(19) United States
(12) Patent Application Publication
(10) Pub. No.: US 2009/0211255 A1
(43) Pub. Date: Aug. 27, 2009

(54) GAS TURBINE COMBUSTOR FLAME STABILIZER

(75) Inventors: Derrick Walter Simons, Greer, SC (US); Geoffrey D. Myers, Simpsonville, SC (US); Larry L. Thomas, Flat Rock, NC (US); Jeffrey Lebegue, Simpsonville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/035,225

(22) Filed: Feb. 21, 2008

(51) Int. Cl. F02C 1/00

(52) U.S. Cl. 60/737; 60/749

(57) ABSTRACT

A gas turbine combustor is presented, which includes a combustion chamber that is positioned downstream of a premixing chamber. The premixing chamber includes at least one opening for ingesting air. At least one primary fuel nozzle is disposed to discharge fuel into the premixing chamber. The fuel discharged from the primary fuel nozzle mixes with the ingested air in the premixing chamber to provide a fuel air mix. A secondary fuel nozzle is disposed proximate the combustion chamber to discharge fuel at the combustion chamber. A stabilizer is disposed at the secondary fuel nozzle so as to be positioned in close proximity to a flame when fuel at the secondary fuel nozzle is ignited. The stabilizer is composed of a material having the ability to absorb heat from a heat flux generated within the combustor and maintaining a temperature sufficient to sustain ignition of the flame. A method of stabilizing a flame in a gas turbine combustor is also presented. The method including discharging fuel at a combustion chamber of the gas turbine combustor and positioning a stabilizer in close proximity to a flame when the fuel at a combustion chamber is ignited. The stabilizer absorbing heat from a heat flux generated within the combustor and maintaining a temperature sufficient to sustain ignition of the flame.

### BACKGROUND OF THE INVENTION

This invention relates generally to a gas turbine combustor. More specifically, the invention relates to a flame stabilizer disposed at a fuel nozzle of the gas turbine combustor, whereby the combustor is operable with leaner premixed fuel air mixtures resulting in lower nitric oxide emissions.

Typically, a gas turbine combustor has both primary and secondary fuel nozzles. Such combustors have four modes of operation, which are primary, lean-lean, secondary, and premix. The primary mode is used for ignition of the combustor with fuel being delivered to the primary nozzles only. In the lean-lean mode the secondary nozzle is also ignited with fuel being delivered to both the primary and secondary nozzles. In the secondary mode fuel is only delivered to the secondary nozzle, thereby extinguishing the flame at the primary nozzles. Then in the premix mode fuel is delivered to both the primary and secondary nozzles, but the flame only exist at the secondary nozzle area, with the premixed fuel air mixture being optimized for desired performance including reduced nitric oxide emissions.

In seeking to lower the nitric oxide emissions of the combustors, they are often operated under lean conditions. However, operating under lean conditions runs the risk of lean blowout. Lean blowout occurs when operating under lean conditions and a change occurs, such as flow disturbance. Blowout results in the combustor transferring back to lean-lean mode or even shutting down, and respectively retransfer into premix or requiring re-ignition, as discussed above. To avoid lean blowout many combustors are run at richer conditions, but these conditions result in a higher flame temperature and greater nitric oxide emissions.

Government emissions regulations have become increasingly concerned with pollutant emission of gas turbines, such as nitric oxide.

U.S. Pat. No. 6,026,644 discloses a concaved cone shaped nozzle with turbulence promoters to promote a desired flame shape. The flame shape is disclosed as being more stable such that it is less susceptible to flow disturbances, thereby allowing leaner operation.

### SUMMARY OF THE INVENTION

A gas turbine combustor is presented, which includes a premixing chamber and a combustion chamber. The premixing chamber includes at least one opening for ingesting air. At least one primary fuel nozzle is disposed to discharge fuel into the premixing chamber. The fuel discharged from the primary fuel nozzle mixes with the ingested air in the premixing chamber to provide a fuel air mix. The combustion chamber is positioned downstream of the premixing chamber. A secondary fuel nozzle is disposed proximate the combustion chamber to discharge fuel at the combustion chamber. A stabilizer is disposed at the secondary fuel nozzle so as to be positioned in close proximity of a flame when fuel at the secondary fuel nozzle is ignited. The stabilizer is composed of a material having the ability to absorb heat from a heat flux generated within the combustor and maintaining a temperature sufficient to sustain ignition of the flame.

A fuel nozzle for use in a gas turbine combustor is also presented, which includes a fuel nozzle and a stabilizer disposed at the fuel nozzle so as to be positioned in close proximity of a flame when the fuel nozzle is ignited. The stabilizer is composed of a material having the ability to absorb heat from a heat flux generated within the combustor and maintaining a temperature sufficient to sustain ignition of the flame.

A method of stabilizing a flame in a gas turbine combustor is presented. The method including discharging fuel at a combustion chamber of the gas turbine combustor and positioning a stabilizer in close proximity of a flame when the fuel at a combustion chamber is ignited. The stabilizer absorbing heat from a heat flux generated within the combustor and maintaining a temperature sufficient to sustain ignition of the flame.

### BRIEF DESCRIPTION OF THE DRAWINGS

FIG. 1 is a simplified representation of a cross section of a gas turbine combustor system of an exemplary embodiment of the present invention; and

FIG. 2 is a cross section of a flame stabilizer of the gas turbine combustor system of FIG. 1.

### DETAILED DESCRIPTION OF THE INVENTION

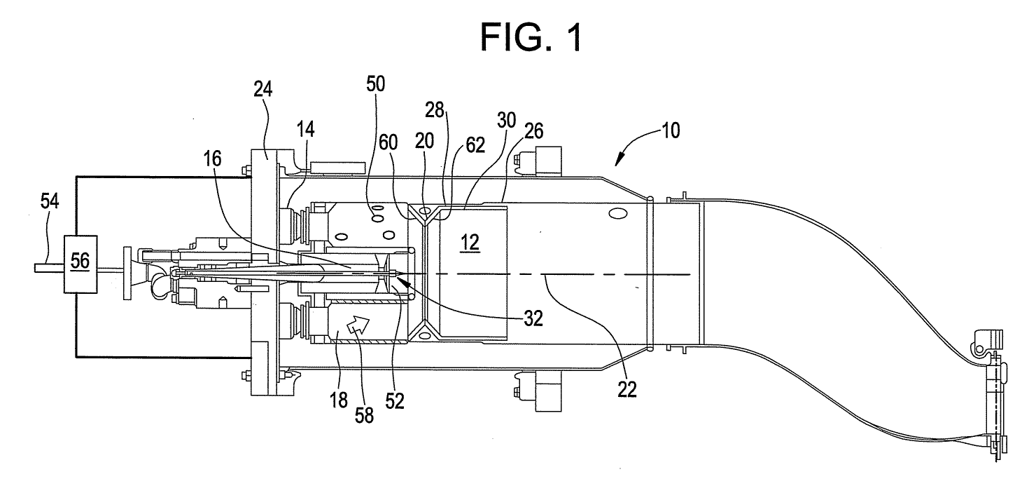

Referring to FIG. 1, a gas turbine combustor of an embodiment of the invention is generally shown at 10. The gas turbine combustor 10 includes generally a combustion chamber 12, primary fuel nozzles 14 (some gas turbines, as illustrated here, employ multiple nozzles in each combustor), a secondary fuel nozzle 16, an annual premixing chamber 18, and a venturi 20. The combustion chamber 12 is generally cylindrical in shape about a combustor centerline 22 and is enclosed by a wall 24 and a combustion liner 26. The substantially cylindrical combustion liner 26 comprises an upper wall 28 and a lower wall 30, defining the combustion chamber 12.

The gas turbine combustor 10 has four modes of operation, which are primary, lean-lean, secondary, and premix.

The primary mode is used for ignition of the combustor 10 with fuel 54 being delivered to the primary nozzles 14 only. Airflow is provided into the premixing chamber 18 through entry ports 50. It will be appreciated that primary fuel nozzle tip vanes and cooling circuits are not shown, in an effort to simplify the FIG. 1. Fuel 54 is provided through a fuel flow controller 56 to the primary fuel nozzles 14. The fuel air mix is then ignited by a spark plug (not shown) or other conventional mean of ignition, causing combustion within the premixing chamber 18 at the primary fuel nozzles 14.

In the lean-lean mode the secondary nozzle 16 is also ignited with fuel 54 being delivered to the primary and secondary nozzles, 14 and 16, respectively. About 60% of fuel 54 is supplied to the primary fuel nozzles 14 and about 40% percent of the fuel 54 is supplied to the secondary fuel nozzle 16. The secondary nozzle 16 ignites from the flame of the primary nozzles 14. This generates a desirable heat flux causing the flame stabilizer's 32 elongated member 34 to heat exponentially.

In the secondary mode fuel 54 is only delivered to the secondary nozzle 16, thereby extinguishing the flame at the primary nozzles. While combustion in the combustion chamber 12 continues at an even higher rate, nitric oxide emissions have not been reduced.

Then in the premix mode fuel 54 is delivered to both the primary and secondary nozzles, 14 and 16, respectively, but the flame only exist at the secondary nozzle 16. About 80% of the fuel 54 is then supplied in the primary fuel nozzle 14 and about 20% of the fuel is supplied to the secondary fuel nozzle 16. Fuel 54 from the primary fuel nozzles 14 is premixed with air induced from the entry ports 50 to create a fuel air mix within the premix chamber 18. This fuel air mix has not yet been ignited, and travels in a downstream direction, as indicated by arrows 58, toward combustion chamber 12. Where convergent/divergent walls, 60 and 62 of a venturi 20 constricts the flow of the fuel air mix. The flow constriction introduced by the venturi 20 will cause acceleration of the mix as it passes the convergent wall 60 based upon Bernoulli's Principle, whereby an increase in velocity comes with a decrease in pressure. Accordingly, this causes the fuel air mix to accelerate into the combustion chamber 12, while maintaining the flame in the combustion chamber 12. The fuel air mix is ignited in the combustion chamber 12 by the flame at the secondary fuel nozzle 16. Greatly enhancing the flame in the combustion chamber, 12 and, whereby increased heat flux is generated.

A flame stabilizer assembly 32 is mounted at the secondary fuel nozzle 16. The flame stabilizer assembly 16 takes advantage of heat flux generated in the combustion chamber 12.

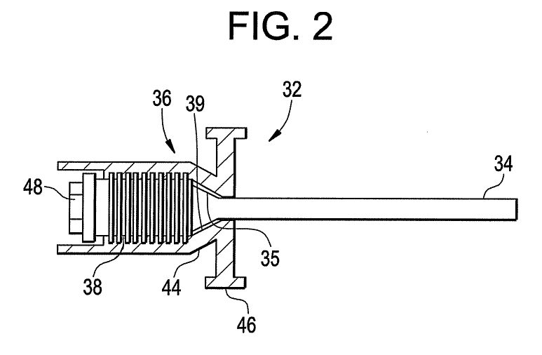

Referring to FIG. 2, the flame stabilizer assembly 32 includes an elongated member 34 having a generally cylindrical shape. While a generally cylindrical shape has been shown and described, it will be appreciated that other shapes (such as generally conical) may be utilized to define the member 34 without departing from the spirit or scope of the invention. The member 34 has a length sufficient to extend beyond the secondary fuel nozzle 16 and in close proximity to or into the flame. Member 34 is composed of any suitable material having the ability to heat up and retain the high temperature resulting from the heat flux. Such material includes, but is not limited to, tungsten and tungsten alloys. Member 34 further includes one end thereof being flared outwardly as defined by surface 35.

A generally cylindrical holder 36 supports member 34, with holder 36 being secured in the secondary nozzle 16. The holder 36 has an opening 38 therethrough with one end of the opening being threaded and the other end being tapered inwardly, as defined by a surface 39. Member 34 is inserted into the opening 38 of holder 36 such that surface 35 of member 34 interfaces or engages with surface 39 of the holder 36. A threaded member (e.g., a screw or bolt) 48 is treaded into the treaded opening securing the engagement of surface 35 of member 34 with surface 39 of the holder 36. The holder 36 further includes outwardly extending shoulder portion 46, which supports assembly 32 against the secondary fuel nozzle 16.

The combustor 10 may be operated under more lean conditions to further reduce nitric oxide emissions. Lean blowout will be significantly reduced, since the member 34 will provide continuous ignition to the fuel discharging from the secondary fuel nozzle 16. Accordingly, should there be an event such as, for example, flow disturbance, that may have otherwise caused a blowout; such a blowout will not occur as the member 34 will be providing a continuous ignition to the fuel discharging from the secondary fuel nozzle 16.

While preferred embodiments have been shown and described, various modifications and substitutions may be made thereto without departing from the spirit and scope of the invention. Accordingly, it is to be understood that the present invention has been described by way of illustrations and not limitation.

1. A gas turbine combustor comprising:
a premixing chamber including at least one opening for ingesting air;
at least one primary fuel nozzle disposed to discharge fuel into the premixing chamber, wherein the fuel discharged from the primary fuel nozzle mixes with the ingested air in the premixing chamber providing a fuel air mix;
a combustion chamber positioned downstream of the premixing chamber;
a secondary fuel nozzle disposed proximate the combustion chamber to discharge fuel at the combustion chamber; and
a stabilizer disposed at the secondary fuel nozzle so as to be positioned in close proximity of a flame when fuel at the secondary fuel nozzle is ignited, the stabilizer is composed of a material having the ability to absorb heat from a heat flux generated within the combustor and maintaining a temperature sufficient to sustain ignition of the flame.

2. The gas turbine combustor of claim 1 further comprising:
a venturi positioned between the premixing chamber and the combustion chamber, wherein the venturei constricts flow of the fuel air mix from the premixing chamber into the combustion chamber, white maintaining a flame in the combustion chamber.

3. The gas turbine combustor of claim 1 wherein the stabilizer comprises:
an elongated member positioned at one end thereof at the secondary fuel nozzle and projecting at the other end thereof towards the combustion chamber.

4. The gas turbine combustor of claim 3 wherein the elongated member is generally cylindrical or generally conical.

5. The gas turbine combustor of claim 3 further comprising:
a holder configured to be supported at the secondary fuel nozzle and engaging the end of the elongated member at the secondary fuel nozzle to hold the elongated member.

6. The gas turbine combustor of claim 5 wherein:
the end of the elongated member at the secondary fuel nozzle is flared; and
the holder has an opening therethrough with one end of the opening being tapered, wherein the elongated member is inserted through the opening of the holder such that the end of the elongated member that is flared engages the end of the opening that is tapered.

7. The gas turbine combustor of claim 6 wherein:
another end of the holder has the opening treaded; and
further comprising a threaded member which engages the opening that is treaded and secures the elongated member to the holder.

8. The gas turbine combustor of claim 1 wherein the material comprises tungsten or a tungsten alloy.

9. A fuel nozzle for use in a gas turbine combustor, comprising:
a fuel nozzle; and
a stabilizer disposed at the fuel nozzle so as to be positioned in close proximity of a flame when fuel at the fuel nozzle is ignited, the stabilizer is composed of a material having the ability to absorb heat from a heat flux generated within the combustor and maintaining a temperature sufficient to sustain ignition of the flame.

10. The fuel nozzle of claim 9 wherein the stabilizer comprises:
an elongated member positioned at one end thereof at the secondary fuel nozzle and projecting outwardly thereof.

11. The fuel nozzle of claim 10 wherein the elongated member is generally cylindrical or generally conical.

12. The fuel nozzle combustor of claim 9 wherein the material comprises tungsten or a tungsten alloy.

13. A method of stabilizing a flame in a gas turbine combustor, comprising:
discharging fuel at a combustion chamber of the gas turbine combustor;
positioning a stabilizer in close proximity of a flame when the fuel at a combustion chamber is ignited;
the stabilizer absorbing heat from a heat flux generated within the combustor; and
the stabilizer maintaining a temperature sufficient to sustain ignition of the flame.

14. The method of claim 13 further comprising:
mixing fuel and air in a premixing chamber to provide a fuel air mix;
constricting flow of the fuel air mix from the premixing chamber into the combustion chamber;
accelerating the fuel air mix into the combustion chamber; and
maintaining a flame in the combustion chamber.
